(19) United States
(12) Patent Application Publication
(10) Pub. No.: US 2021/0050728 A1
(43) Pub. Date: Feb. 18, 2021

(54) INVERTER ARRANGEMENT FOR WIND POWER INSTALLATIONS AND PHOTOVOLTAIC INSTALLATIONS

(71) Applicant: Wobben Properties GmbH, Aurich (DE)

(72) Inventor: Johannes Brombach, Berlin (DE)

(21) Appl. No.: 16/991,722

(22) Filed: Aug. 12, 2020

(30) Foreign Application Priority Data
Aug. 14, 2019 (DE) 102019121893.4

(51) Int. Cl. H02J 3/38; H02S 10/12; H02S 40/32; H02J 3/32; F03D 9/00

(52) U.S. Cl. CPC H02J 3/381; H02S 10/12; H02S 40/32; F05B 2220/708; F03D 9/007; H02J 2300/28; H02J 2300/24; H02J 3/32

(57) ABSTRACT

The disclosure relates to an inverter arrangement having a plurality of inverters, wherein each inverter has a DC voltage intermediate circuit and an AC current output in order to generate an AC current from a DC voltage at the DC voltage intermediate circuit and to output the AC current at the AC current out-put, and the inverter arrangement has an intermediate circuit switching device designed to electrically connect or to isolate the DC voltage intermediate circuits of a plurality of inverters in order to form at least one first and one second partial intermediate circuit, and to galvanically connect the DC voltage intermediate circuits of the inverters in each case selectively to the first or second or possibly a further partial intermediate circuit, wherein the first and the second partial intermediate circuit and possibly further partial intermediate circuits are galvanically isolated from one another.

### BACKGROUND

### Technical Field

The present disclosure relates to an inverter arrangement having a plurality of inverters. The present disclosure also relates to a renewable energy generation installation having an inverter arrangement. The present disclosure also relates to a method for controlling an inverter arrangement and/or for controlling a renewable generation installation.

### Description of the Related Art

Wind power installations and wind farms having a plurality of wind power installations are known and may be grouped together under the term wind power system. Such a wind power system generates electric power from wind and provides said power for infeed into an electricity supply grid by way of at least one inverter. Photovoltaic installations are likewise known, and these generate electric power from solar irradiation and likewise feed said electric power generated in this way into an electricity supply grid. Solar irradiation may also be referred to synonymously as solar radiation.

If a wind power system and a photovoltaic installation are installed in the spatial vicinity of one another, it comes into consideration to use a joint grid connection point to which these two different feeders are connected.

By way of example, it comes into consideration for a photovoltaic installation to be connected to the electricity supply grid at a pre-existing grid connection point of a wind power system. A joint connection of a wind power system and of a photovoltaic installation may be particularly worthwhile due to a strong anti-correlation between the infeed of wind power, on the one hand, and solar irradiation, on the other hand.

It comes into consideration in this case for the grid connection point and parts of the technical infrastructure to be used jointly, which may save on costs.

In principle, different levels of integration are conceivable, specifically as follows:
Only the grid connection point is used jointly by both systems, that is to say the wind power system and the photovoltaic installation, possibly also a high-voltage transformer.
Joint use of medium-voltage switchgear additionally comes into consideration.
Joint use of a medium-voltage transformer also comes into consideration, wherein the wind power system, on the one hand, and the photovoltaic installation, on the other hand, may each have a dedicated inverter on the low-voltage side.
A joint connection at an intermediate circuit also in principle comes into consideration, wherein each system, that is to say the wind power system, on the one hand, and the photovoltaic installation, on the other hand, have a dedicated DC chopper in order thereby to transmit their energy to the joint DC voltage intermediate circuit.

If for example a photovoltaic installation is to be connected to the DC voltage intermediate circuit of a wind power system, that is to say for example of a wind power installation, the operating voltage of the photovoltaic installation has to be adapted to the intermediate circuit voltage of this wind power installation, and the photovoltaic installation has to be galvanically isolated from the wind power installation under certain circumstances.

Implementing such requirements may however be complicated and expensive, and renewable feeders therefore normally have dedicated grid connection points with a dedicated technical infrastructure.

### BRIEF SUMMARY

One or more embodiments are directed to techniques that are as efficient as possible for connecting a wind power system together with a photovoltaic installation to an electricity supply grid at the same grid connection point.

In one embodiment an inverter arrangement has a plurality of inverters, in particular at least three inverters. More than three inverters are however preferably present, in particular at least 10 and more than 10 inverters.

Each inverter has a DC voltage intermediate circuit and an AC current output in order to generate an AC current from a DC voltage in the DC voltage intermediate circuit and to output said AC current at the AC current output. In this respect, the DC voltage intermediate circuit may be considered to be an input in order thereby to provide power to the inverter. An AC current is then generated from the DC voltage intermediate circuit and output at the AC current output. In this respect, the inverter operates in a known manner. The power that has been input into the DC voltage intermediate circuit is thereby able to be output by way of the AC current that is generated in particular in the form of a three-phase AC current, and fed into an electricity supply grid together with further AC currents. This is performed in particular at a grid connection point. There may also be provision for a joint transformer for the inverter arrangement, which joint transformer is able to generate a relatively high-voltage joint AC current from the AC currents of these inverters.

In this case, a plurality of inverters may for example be connected in parallel, which may in principle be assumed to be known.

It is then proposed for the inverter arrangement to have an intermediate circuit switching device. The DC voltage intermediate circuits of these inverters are thus electrically connected to one another or isolated from one another. At least one first and one second partial intermediate circuit are thereby formed. Thus, if for example 10 inverters are present, these each have a DC voltage intermediate circuit, such that 10 DC voltage intermediate circuits are initially present. Of these 10 DC voltage intermediate circuits, 7 may then for example be connected to form the first partial intermediate circuit and the remaining 3 may be connected to form a second partial intermediate circuit.

The DC voltage intermediate circuits of a respective partial intermediate circuit are thus galvanically connected to one another, galvanic isolation however taking place between the two partial intermediate circuits. The first and second DC voltage intermediate circuit may then be operated independently of one another. They may in particular have different voltage levels, which also means that one partial intermediate circuit may have fluctuations that differ from fluctuations of the other partial intermediate circuit, if this has fluctuations at all, specifically fluctuations in the amplitude of the respective intermediate circuit voltage.

As a result of the intermediate circuit switching device, it is possible in this case to design such a division in a first and second partial intermediate circuit to be variable. In said example of 7 inverters for the first partial intermediate circuit and 3 inverters for the second partial intermediate circuit, the division may also be changed, for example in that the first partial intermediate circuit comprises 5 inverters following a further actuation of the intermediate circuit switching device, and the second partial intermediate circuit then likewise comprises 5 inverters.

Such variability is intended in particular for the use of the inverter arrangement for a renewable generator system that comprises at least a wind power system and a photovoltaic installation. The wind power system may have one wind power installation or a plurality of wind power installations. The photovoltaic installation may also consist of a plurality of individual single photovoltaic installations. If the wind power system feeds the first partial intermediate circuit and the photovoltaic installation feeds the second partial intermediate circuit, then the division of the inverters between first and second partial intermediate circuit may be performed depending on the respectively generated power.

Thus, if the wind is strong and the solar irradiation is weak, the first example comes into consideration in which 7 inverters or their DC voltage intermediate circuits are connected together to form the first partial intermediate circuit and the remaining 3 inverters or their DC voltage intermediate circuits are connected together to form the second partial intermediate circuit. It has in particular been recognized here that wind power systems and photovoltaic installations that are installed in the vicinity of one another rarely generate a high power at the same time. Instead, there is often an anti-correlation between the two systems, according to which a cloudless sky with strong solar irradiation rarely occurs at the same time as strong wind, whereas strong wind often occurs together with considerable cloud formation, meaning that solar irradiation is then somewhat weak.

It has also been recognized that modern wind power installations operate such that electric power is generated using a synchronous generator, rectified and then fed to a DC voltage intermediate circuit as rectified current. It has likewise been recognized that photovoltaic installations also generate a DC current and provide it to a DC voltage intermediate circuit. In both cases, an AC current may then be produced based on the respective DC voltage intermediate circuit by way of an inverter.

In spite of similar voltage amplitudes in both DC voltage intermediate circuits, the voltages and/or voltage profiles of such DC voltage intermediate circuits may still differ. In the case of a photovoltaic installation, it in particular comes into consideration that its operating point is set via the voltage level at the DC voltage intermediate circuit or at least the voltage level at the DC voltage intermediate circuit depends on a DC voltage that was selected in order to set the operating point of the photovoltaic installation. This is based in particular on the finding that a photovoltaic installation constantly sets its operating point in accordance with what is known as an MPP tracking method. Such a method denotes the technical procedure according to which a maximum operating point is almost constantly sought, that is to say an operating point at which maximum power is able to be generated. This may in particular have effects on the voltage profile in the corresponding DC voltage intermediate circuit of the downstream inverter. Accordingly, this additionally results in a difference with respect to a DC voltage intermediate circuit of an inverter that is fed by a generator of a wind power installation.

It has also been recognized that the individual inverter is tolerant to such different voltage levels. An inverter in principle generates an AC current having a certain AC voltage amplitude from the DC voltage of a DC voltage intermediate circuit. The voltage range for the DC voltage intermediate circuit is also defined through this AC voltage amplitude. As long as the voltage level of the DC voltage intermediate circuit is however within this defined region, voltage fluctuations, that is to say voltage fluctuations within this range, do not constitute a problem for the inverter, and the inverter is able to adapt to such variations and respond for example through adapted pulse behavior.

It is in particular proposed for each inverter to operate using a tolerance band method. In the case of such a tolerance band method, a tolerance band within which the generated current should lie is predefined for the output current to be generated. If the generated current goes outside of one of the two tolerance band limits, which specifically define the tolerance band, corresponding switching is performed in the inverter. The corresponding pulse pattern is thereby generated in the case of a tolerance band method. The tolerance band method is in this respect a control operation in which the switching behavior of the inverter is always tracked depending on the generated current, and specifically always with respect to the instantaneous values.

It has additionally been recognized that, when the voltage in the DC voltage intermediate circuit changes, this is immediately reflected in the switching behavior on account of the direct and immediate measurement of the generated output current, but the generated current continues to be generated such that it lies within the tolerance band.

On the basis of this, it has thus been recognized that the DC voltage intermediate circuit of each inverter is suitable both for operation with a wind power system and for operation with a photovoltaic installation. The differences that result between the wind power system and the photovoltaic installation should however be taken into consideration to the extent that the respectively generated DC voltages should be galvanically isolated from one another. This is achieved by the intermediate circuit switching device. Said intermediate circuit switching device may also be used to achieve a situation whereby correspondingly more or fewer inverters are connected to the wind power system according to need, specifically depending on how much wind power is currently available in comparison to how much power from solar irradiation is currently available, and correspondingly more or fewer inverters are connected to the photovoltaic installation.

As a result of the intermediate circuit switching device, it is thus easily possible to create a power-dependent division between the wind power system, on the one hand, and the photovoltaic installation, on the other hand. The variable formation of the first and second partial intermediate circuit on its own creates the option of providing a corresponding inverter capacity for the wind power system or the photovoltaic installation.

It is thus proposed to divide the DC voltage intermediate circuits of the inverters into a first and a second partial intermediate circuit. As an expansion, however, it also comes into consideration for an energy store, in particular a battery, to be jointly incorporated via a third partial intermediate circuit. It furthermore comes into consideration also to provide another fourth partial intermediate circuit in the same way, if for example a consumer is furthermore intended to be supplied via the DC voltage intermediate circuit. In this respect, it also comes into consideration for each inverter to operate bidirectionally, that is to say not only to generate an AC current from its DC voltage intermediate circuit, but rather also to be able to convert an AC current into a DC current and feed said DC current into the DC voltage intermediate circuit. This comes into consideration when electric power is intended to be drawn from the electricity supply grid, in particular for a grid support measure.

According to one variant, there may however be provision for only a total of three partial intermediate circuits to be used, and said energy store may thus be used as an additional generator and alternatively as an additional consumer and both may be implemented at a partial intermediate circuit, in particular at said third partial intermediate circuit.

According to one embodiment, it is proposed for inverters whose DC voltage intermediate circuit is connected to the first partial intermediate circuit to be combined to form an inverter sub-arrangement in order to generate a first partial AC current, and for inverters whose DC voltage intermediate circuit is connected to the second partial intermediate circuit to be combined to form a second inverter sub-arrangement in order to generate a second partial AC current, wherein the first and second partial AC current are combined to form an overall AC current to be fed into an electricity supply grid and inverters may be assigned selectively to the first or second inverter arrangement at least by way of the intermediate circuit switching device.

This embodiment achieves the possibilities explained above of dividing the number of inverters between a wind power system and a photovoltaic installation according to need even better. Preferably, as many inverters as are required to generate and feed in an AC current for the wind power system are always accordingly combined to form a first inverter sub-arrangement, whereas correspondingly many or few inverters are combined to form the second inverter sub-arrangement in order to convert the power generated by the photovoltaic installation into an AC current and process it in order to feed it into the electricity supply grid.

The assignment may take place selectively, and this takes place in particular depending on the electric power fed to the first or second inverter sub-arrangement or the available electric power to be fed in.

According to one embodiment, it is proposed for the AC current outputs of the inverters, at least the AC current outputs of inverters of different inverter sub-arrangements, to be galvanically isolated from one another. As a result, it is possible to guarantee operational safety and/or it is possible to avoid transverse currents or circuit currents that could otherwise occur, for example via a ground potential. Due to the fact that the AC current outputs are galvanically isolated from one another, it is possible to guarantee independent operation of the inverters from one another. It may however be sufficient for galvanic isolation to be guaranteed only between the inverters of the first inverter arrangement, on the one hand, and the inverters of the second inverter arrangement, on the other hand. It however comes into consideration for each inverter, at its AC current output, to be galvanically isolated from all of the other inverters or a plurality of AC current outputs, for example through an individual transformer at the output of each inverter. It also comes into consideration for a transformer to have a winding for each inverter at the input side, or on its primary side. Both variants would have the advantage that, in the case of a change of the assignment of the inverters to the first and/or second inverter arrangement, such galvanic isolation does not need to be adapted.

In particular the variant of providing a transformer having a respective winding for each inverter, specifically for each inverter output, may be an inexpensive solution in which specifically each winding needs to be designed only for the respective inverter. In comparison with the variant of providing galvanic isolation only between the inverters of the first inverter arrangement, on the one hand, and the inverters of the second inverter arrangement, on the other hand, this has the advantage that the transformer is able to be dimensioned in a targeted manner on the input side.

For galvanic isolation only between the inverters of the first inverter arrangement, on the one hand, and the inverters of the second inverter arrangement, on the other hand, a transformer having only two isolated windings on the input side may be provided. A transformer having two such windings on the input side is able to be produced with comparatively little expenditure, but the windings on the input side have to be dimensioned to be large as a precaution, because the size of the first and second inverter arrangement may vary. On the other hand, providing in particular a corresponding switching arrangement in order to guarantee galvanic isolation between the individual inverter sub-arrangements can be implemented in a structurally simple manner and with little expenditure in terms of costs.

It is in particular proposed for the inverters, at least the inverters of the different inverter arrangements, to be connected to a transformer having at least two primary windings such that their AC currents are overlaid in the transformer to form a joint AC current. It in particular comes into consideration here for galvanic isolation to be provided only between the two inverter sub-arrangements. As a result, two partial AC currents that are galvanically isolated from one another may then be output. These may then be input into a first and second primary winding of a transformer and overlaid in this transformer. The transformer may then have a single secondary-side winding and thus a single secondary-side output at which an overall current may then be generated or output in order then to be fed into the electricity supply grid.

It also comes into consideration in principle for such a transformer to have more than two primary windings, which may however be technically complicated.

According to one refinement, it is proposed for the inverter arrangement to have an output current switching device that is designed to electrically connect or to isolate AC current outputs of a plurality of inverters in order to form a first and a second partial current output, and to galvanically connect the AC current outputs of the inverters in each case selectively to the first or second partial current output, wherein the first and the second partial current output are galvanically isolated from one another by the output current switching device. There is in particular provision for the output current switching device to be synchronized with the intermediate circuit switching device, that is to say that the first partial current output is assigned to the first inverter arrangement and the second partial current output is assigned to the second inverter sub-arrangement.

In this case too, the described transformer is preferably provided with at least two primary windings, wherein the first partial current output is connected to the first primary winding and the second partial current output is connected to the second primary winding in order to overlay the two partial output currents firstly in the transformer.

The described galvanic isolation of the AC current outputs or the described galvanic combination of the AC current outputs may be achieved as a result of this output current switching device. As a result of the proposed synchronization between the output current switching device and the intermediate circuit switching device, inverters are assigned to one of the inverter sub-arrangements both at their DC voltage intermediate circuit and at their AC current output. In both cases, it is possible to create a galvanic connection to the inverter sub-arrangement to which they are newly assigned, and it is possible to create galvanic isolation from the inverter sub-arrangement to which the inverter was previously assigned.

In this case too, it comes into consideration in principle for a third and yet more inverter sub-arrangements to be provided, and for these also to be connected accordingly in the region of their AC current outputs by way of a corresponding output current switching device.

According to one refinement, it is proposed for the first partial intermediate circuit to have a wind power terminal for connection to a wind power system in order thereby to receive electric power generated by the wind power system, and for the second partial intermediate circuit to have a photovoltaic terminal for connection to a photovoltaic installation in order thereby to receive electric power generated by the photovoltaic installation. To this end, it is proposed for the inverter arrangement to be designed such that the intermediate circuit voltage differs between the first and second partial intermediate circuit. It is in particular proposed for an intermediate circuit voltage to be set depending on an operating point of the photovoltaic installation at the second partial intermediate circuit.

The inverter arrangement may thus be connected simultaneously to a wind power system and a photovoltaic installation via these two terminals, that is to say the wind power terminal and the photovoltaic terminal. The inverter arrangement may then simultaneously feed the power from both energy generators into the electricity supply grid. Wind power system is the name given here to a single wind power installation or a plurality of wind power installations that feed into the electricity supply grid via the same grid connection point. This may also incorporate a wind farm.

The intermediate circuit voltages may in this case differ between the first and second partial intermediate circuit, and this may in particular be achieved by virtue of the fact that the partial intermediate circuits are galvanically isolated from one another. It is furthermore proposed for the inverters to be tolerant to variations in the intermediate circuit voltages at their DC voltage intermediate circuit. The inverter arrangement may thereby be designed such that the intermediate circuit voltages differ between the first and second partial intermediate circuit. Said galvanic isolation permits such differences, and the inverters are tolerant to such voltage fluctuations. One possibility for making an inverter tolerant to voltage fluctuations at the DC voltage intermediate circuit may be implemented by virtue of the fact that the inverter operates in accordance with the tolerance band method and/or the inverters are dimensioned such that a sufficiently large current is always able to be fed into the grid even in the event of voltage variability.

Due to the fact that the two intermediate circuit voltages may differ from one another, it is preferably made possible for the second partial intermediate circuit to set its intermediate circuit voltage such that a desired operating point in the photovoltaic installation is thereby found. What is known as an MPP tracking method may in particular be performed for the photovoltaic installation by way of the intermediate circuit voltage of the second partial intermediate circuit. It however also comes into consideration for this MPP tracking method to be performed at the photovoltaic installation itself and not in the second partial intermediate circuit, but resultant voltage variations at the photovoltaic installation may also lead to variations in the intermediate circuit voltage at the second partial intermediate circuit.

According to one variant, the photovoltaic installation has an additional intermediate circuit that is connected to the second partial intermediate circuit via a DC chopper, which is also referred to as DC-to-DC converter. This has the advantage that the intermediate circuit voltage at the second partial intermediate circuit is able to be set according to the grid voltage and the reactive power demand. In this case, for this variant too, galvanic isolation is able to be guaranteed between the first and second partial intermediate circuit. The DC-to-DC converter is thereby able to be designed inexpensively without galvanic isolation.

According to one embodiment, it is proposed for the wind power system and the photovoltaic installation, which are connected to the inverter arrangement specifically at the wind power terminal or the photovoltaic terminal, respectively, to each be characterized by a nominal power. Such characterization by a nominal power is normal, and such a nominal power may often also represent a maximum power of the respective system that should not be exceeded during normal operation. Although these two nominal powers may in theory be the same, they will usually be different because the wind power system and the photovoltaic installation are usually designed independently of one another. It is preferably assumed that the nominal power of the photovoltaic installation is less than that of the wind power system.

On the basis of this, it is then proposed for the inverter arrangement to have a nominal power that corresponds to the nominal power of the wind power system plus a reserve power. The inverter arrangement is thus designed on the basis of the nominal power of the wind power system. This means in particular that each inverter has a nominal power that it is able to convert at most from DC current to AC current during normal operation, wherein the nominal power of the inverter arrangement is then the sum of all of the nominal powers of the inverters. All of the inverters are preferably dimensioned the same, and the nominal power of the inverter arrangement then corresponds to the nominal power of an inverter multiplied by the number of inverters that are present.

The design of the inverter arrangement may also include the design of a transformer, in particular a high-voltage transformer that is likewise designed for the nominal power of the inverter arrangement.

To this end, it is thus proposed for the nominal power of the inverter arrangement to correspond to the nominal power of the wind power system plus a reserve power. The reserve power may also have a value of 0, but preferably has a greater value, which may be up to 20% or at least up to 10% of the nominal power of the wind power system. The inverter arrangement is thus designed to be only slightly larger than the wind power system.

This is based in particular on the concept that such a design may be sufficient and it is not necessary to design the nominal power of the inverter arrangement with respect to the sum of the nominal powers of the wind power system and of the photovoltaic installation.

As a result of the anti-correlation that has been recognized between available wind power and available solar power, it has also been recognized that a design of the inverter arrangement with respect to the nominal power of the wind power system, possibly increased only by the reserve power, may be sufficient in most cases. It is thus also possible to achieve a situation whereby overall less inverter capacity has to be provided than would be the case if a sufficient inverter arrangement were to be provided in each case for the wind power system, on the one hand, and the photovoltaic installation, on the other hand.

It is preferably proposed for the reserve power to correspond to a value that is less than the nominal power of the photovoltaic installation, in particular less than 50% of the nominal power of the photovoltaic installation. It is accordingly possible to save on inverter capacity to an extent of 50% of the nominal power of the photovoltaic installation or more.

Provided, in at least one embodiment, is a renewable energy generation installation for feeding electric power into an electricity supply grid. Such a renewable energy generation installation comprises a wind power system for generating electric power from wind and a photovoltaic installation for generating electrical energy from solar radiation. What is furthermore provided is an inverter arrangement according to an embodiment described above. The wind power system and the photovoltaic installation are thus connected to this inverter arrangement, which may thus also be referred to as a joint inverter arrangement. The wind power system thus generates power from wind and feeds it into the first partial intermediate circuit via a wind power terminal, and the photovoltaic installation generates electric power from solar radiation and feeds it into the second partial intermediate circuit via the photovoltaic terminal. Depending on available power from wind and available power from solar radiation, the intermediate circuit switching device may assign more inverters to the first or second partial intermediate circuit. The inverter arrangement may thereby be better utilized and differences in the DC voltage that is provided by the wind power system, on the one hand, and that is provided by the photovoltaic installation, on the other hand, are easily able to be taken into consideration.

It is preferably proposed for the renewable energy generation installation to have a controller for controlling the inverter arrangement in order to control the inverter arrangement depending on power currently able to be generated from wind and power currently able to be generated from solar radiation. There is in particular provision for at least the intermediate circuit switching device to be controlled depending on these two available powers, specifically such that a corresponding number of inverters are assigned in each case to the wind power system and the photovoltaic system depending thereon.

It is thus proposed for the wind power system to be connected to the first partial intermediate circuit via the wind power terminal and for the photovoltaic installation to be connected to the second partial intermediate circuit via the photovoltaic terminal. The appropriate number of inverters may thus in each case be assigned to the wind power system and to the photovoltaic installation.

There is preferably provision for an energy store in order to store or to output electrical energy. Furthermore or as an alternative, there is provision for an electrical consumer for consuming electrical energy. To this end, there is then provision for the intermediate circuit switching device to be designed to form a third and optionally, that is to say if necessary, a fourth partial intermediate circuit. The inverters are then thus divided into three or four groups, specifically into three or four inverter sub-arrangements. The size thereof and therefore also the size of the respective partial intermediate circuit may be selected according to the power to be implemented. At least these partial intermediate circuits may then be formed by the intermediate circuit switching device. Furthermore or as an alternative, the division into the inverter sub-arrangements may be supported by the output current switching device.

On the basis of this, there is then provision for the energy store to be connected to the third partial intermediate circuit and for the electrical consumer that is thus provided in addition to the energy store to be connected to the fourth partial intermediate circuit. In the variant in which only an electrical consumer but no energy store is present, the electrical consumer is expediently connected to the third partial intermediate circuit and a fourth partial intermediate circuit then does not need to be formed.

An electrical energy store and/or an electrical consumer is thereby easily able to be jointly integrated into the energy generation installation. The energy store is thereby able to perform energy buffering, in particular when more renewable power is present than is required in the electricity supply grid, and this may be buffer-stored in the energy store.

The conversion may be performed easily by way of the correspondingly adapted inverter arrangement. This thereby avoids a situation whereby additional inverter capacity needs to be provided for the energy store. It is at least possible to achieve a situation whereby less inverter capacity needs to be provided than would be the case if a dedicated inverter arrangement were to be provided for the energy store.

An electrical consumer is able to be integrated into the energy generation installation in the same way. Such an electrical consumer may perform particular tasks, such as for example supplying the controller with electricity. The electrical consumer may however also be provided in order to dissipate a power excess that occurs for grid support purposes.

In any case, electrical stores and consumers, which may also be referred to as loads, are thereby easily able to be integrated into the renewable energy generation installation.

The renewable energy generation installation may in particular be designed as a wind farm having an integrated photovoltaic installation. This is a proposal for all of the embodiments described above.

Provided, in at least one embodiment, is a method for controlling a renewable generation installation. The renewable generation installation is designed in the same way as has been explained above according to at least one embodiment. It additionally has an inverter arrangement that is designed in the same way as has been explained above according to at least one appropriate embodiment.

The method additionally operates in the same way as has been explained in connection with at least one embodiment of the inverter arrangement and/or in connection with the renewable energy generation installation.

There is in particular provision for the method to be implemented on a controller of the renewable energy generation installation.

It is in particular proposed for the method to control the inverter arrangement depending on power currently able to be generated from wind and power currently able to be generated from solar radiation. The intermediate circuit switching device is in particular controlled depending on power currently able to be generated from wind and depending on power currently able to be generated from solar radiation. To this end, the controller may issue corresponding switching commands to the intermediate circuit switching device in order thereby selectively to form or to change the corresponding partial intermediate circuits.

To this end, DC voltage intermediate circuits of individual inverters are each assigned to a partial intermediate circuit, in particular to the first one or to the second one. In order to change the partial intermediate circuits, it in particular comes into consideration for the controller of the intermediate circuit switching device to issue control commands in order to disconnect at least one inverter or its DC voltage intermediate circuit from one partial intermediate circuit and to connect it to the other partial intermediate circuit.

### BRIEF DESCRIPTION OF THE SEVERAL VIEWS OF THE DRAWINGS

The disclosure is now explained in more detail below by way of example on the basis of embodiments with reference to the accompanying figures.

FIG. 1 shows a perspective illustration of a wind power installation.

FIG. 2 shows a schematic illustration of a renewable energy generation installation according to a first embodiment.

FIG. 3 shows a schematic illustration of a renewable energy generation installation according to a second embodiment.

### DETAILED DESCRIPTION

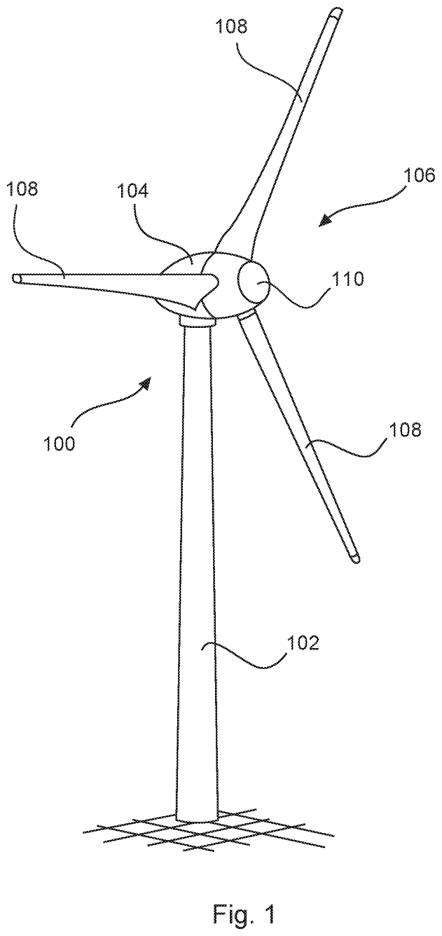

FIG. 1 shows a wind power installation 100 having a tower 102 and a nacelle 104. Arranged on the nacelle 104 is a rotor 106 with three rotor blades 108 and a spinner 110. During operation, the rotor 106 is set in rotational motion by the wind and thereby drives a generator in the nacelle 104.

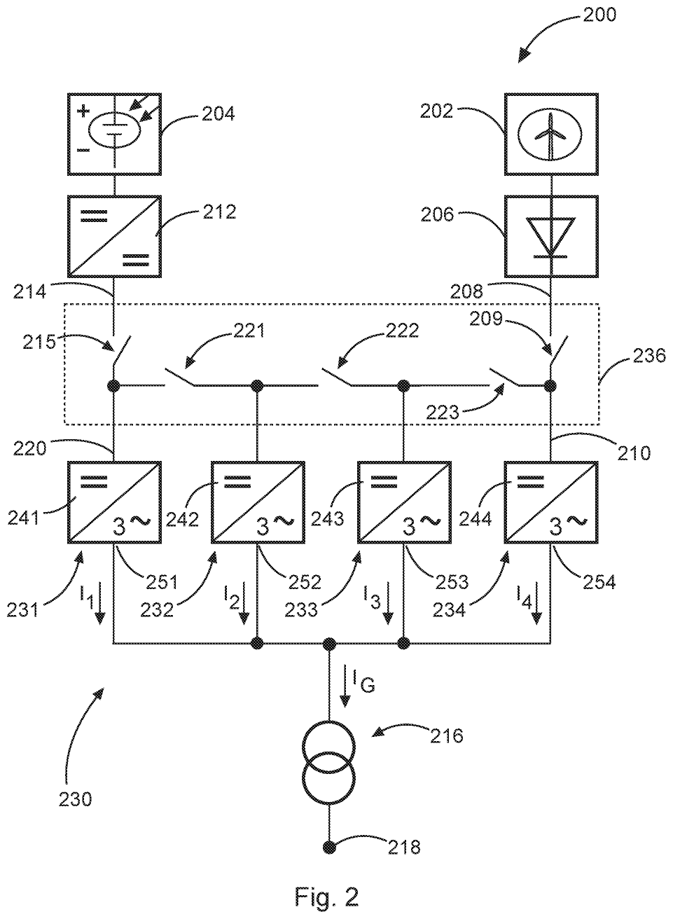

FIG. 2 shows a renewable generation installation 200 having a wind power system 202 and a photovoltaic installation 204. The wind power system 202 is illustrated here in the form of a single wind power installation that is also representative of other wind power systems, such as for example a wind farm. The wind power system 202 feeds a first partial intermediate circuit 210 via a rectifier 206 and a wind power terminal 208. At the same time, the photovoltaic installation 204 feeds a second partial intermediate circuit 220 via a chopper 212, which may be designed as a step-up converter and/or step-down converter, via a photovoltaic terminal 214. The chopper 212 may in this case be optional and it also comes into consideration for the photovoltaic installation 204 to be connected directly to the second partial intermediate circuit 220.

The first partial intermediate circuit 210 and the second partial intermediate circuit 220 are part of an inverter arrangement 230, which has a first to fourth inverter 231 to 234 according to FIG. 2, by way of example. The wind power terminal 208 and the photovoltaic terminal 214 should also be considered to be part, in particular to be input terminals, of the inverter arrangement 230. The inverter arrangement 230 also has an intermediate circuit switching device 236.

Each inverter 231 to 234 has a DC voltage intermediate circuit 241 to 244, and these DC voltage intermediate circuits may also be referred to as first to fourth DC voltage intermediate circuit 241 to 244. Each inverter 231 to 234 furthermore in each case has an AC current output 251 to 254, and these AC current outputs may also be referred to as first to fourth AC current output for the purpose of better differentiation. Each of these AC current outputs 251 to 254 in each case outputs an AC current I₁ to I₄, and these AC currents are overlaid to form an overall current IG. The overall current IG may be routed via a transformer 216 and fed into an electricity supply grid at a grid connection point 218. The transformer 216 may be considered to be part of the inverter arrangement 230, but it may also be an independent element depending on the embodiment.

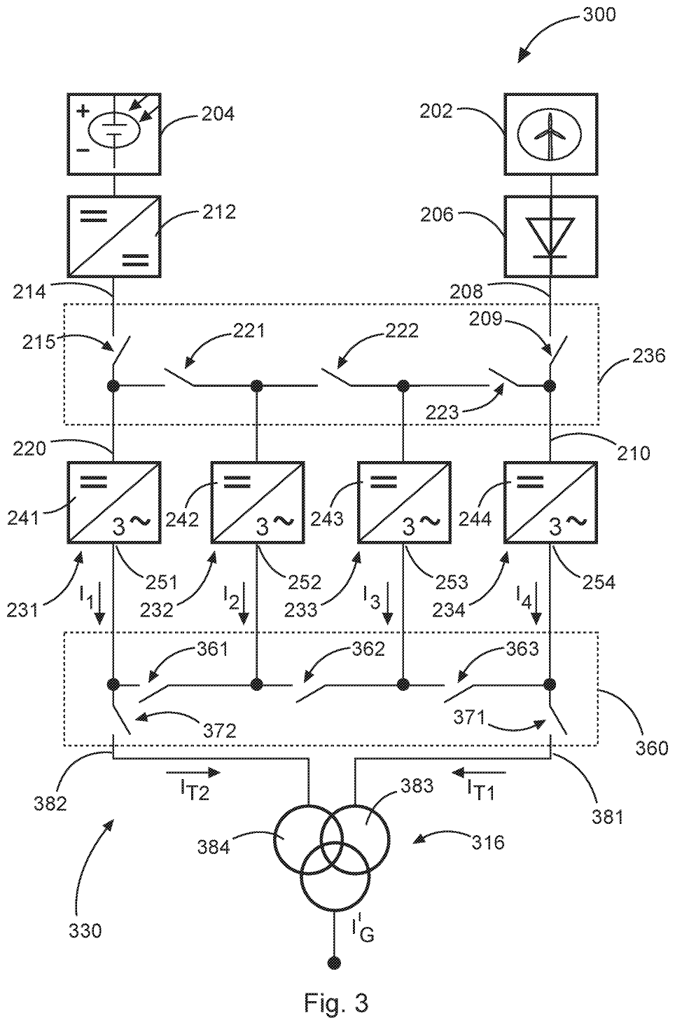

The inverters 231 to 234, and the same applies for FIG. 3, are selected only by way of example, and a higher number of inverters may in particular also be present.

During operation of the renewable energy generation installation 200, the wind power system 202 and the photovoltaic installation 204, depending on wind conditions and solar irradiation, deliver a different amount of power, and this is taken into consideration by way of the intermediate circuit switching device 236. The intermediate circuit switching device 236 to this end has a first, second and third coupling switch 212 to 223. For the sake of the illustration, the three coupling switches 221 to 223 are illustrated in open form in FIG. 2, but preferably only one of these three coupling switches is open. It is pointed out that, when using more than four inverters, correspondingly more coupling switches are also provided. A wind power switch 209 is furthermore provided at the wind power terminal 208, and a photovoltaic switch 215 is provided at the photovoltaic terminal 214. During ongoing operation, these two switches are closed when the wind power system 202 and the photovoltaic installation 204 are feeding in power. By using the switching device 236, which is described in even more detail below, the chopper 212, if this is present at all, may be provided or designed without galvanic isolation.

If it is then assumed by way of example that at present a small amount of solar irradiation but a large amount of wind energy is present, then the second and third coupling switch 222, 223 may be closed, whereas the first coupling switch 221 remains open. The second, third and fourth DC voltage intermediate circuit 242 to 244 thereby form the first partial intermediate circuit 210. The power that was generated from wind by the wind power system 202 is thereby able to be fed into this first partial intermediate circuit 210 and converted into an AC current by way of the second, third and fourth inverter 232 to 234. This AC current is then specifically the sum of the output currents I₂ to I₄.

At the same time, the first DC voltage intermediate circuit 240, that is to say the DC voltage intermediate circuit of the first inverter 230, forms the second partial intermediate circuit 220. In the exemplary example, a small amount of solar radiation has been assumed, and it is thus sufficient to use this one, first inverter 231 in order to convert the power generated by the photovoltaic installation 204 from solar radiation into an AC current, specifically in this case the current I₁.

If the situation then however changes and the solar irradiation increases and the power able to be generated from wind decreases, then the second coupling switch 222 may for example be opened and the first coupling switch 221 may be closed. In this case, the first and second DC voltage intermediate circuit 241 and 242 then form the second partial intermediate circuit, and the third and fourth DC voltage intermediate circuit 243 and 244 then form the first partial intermediate circuit 210. If the available wind power then decreases even further and the solar radiation increases to an even greater extent, then the third coupling switch 223 may be opened and the second coupling switch 222 may be closed. If a small amount of solar irradiation and a small amount of wind power is available, then it also comes into consideration for one of the inverters, or a plurality of the inverters, to remain unused.

FIG. 3 shows a renewable energy generation installation 300 having an inverter arrangement 330 according to a further embodiment. This renewable energy generation installation 300 in FIG. 3 differs from the renewable energy generation installation 200 according to FIG. 2 substantially only through the use of an output current switching device 360 and a changed transformer 316 including a resultant electrical connection between the output current switching device 360 and the transformer 316. For the rest of the elements, the same reference signs as in FIG. 2 are therefore used, and reference is likewise made to the explanation with regard to FIG. 2 for the functionality thereof.

Galvanic isolation at the AC current outputs 251 to 254 of the inverters 231 to 234 is also created by the output current switching device 360. This may be achieved in particular through the output coupling switches 361 to 363. The inverters 231 to 234 may be connected or isolated at output by these output coupling switches 361 to 363. For the purpose of improved clarity, the three output coupling switches 361 to 363 are illustrated in open form. During ongoing operation, only one of the three output coupling switches 361 to 363 is however open when all four inverters 231 to 234 are active. It is in particular proposed for the output coupling switches 361 to 363 to be switched synchronously with the coupling switches 221 to 223, and a corresponding number of the inverters 231 to 234 are thereby able to be assigned to the wind power system 202 or to the photovoltaic installation 204 depending on wind energy that is present and depending on solar irradiation that is present.

A wind power output switch 371 and a photovoltaic output switch 372 are furthermore provided. These are also illustrated in open form in FIG. 3 for the purpose of improved clarity. They are however preferably closed during ongoing operation. They are in particular switched synchronously with the wind power switch 309 and the photovoltaic switch 215. It is proposed for the wind power output switch 371 to be switched synchronously with the wind power switch 209 and for the photovoltaic output switch 372 to be switched synchronously with the photovoltaic switch 215.

These four switches may also serve as a safety switch, but it also comes into consideration, when for example no solar irradiation is present, that is to say in particular at night, and when a large amount of wind energy is available, for the photovoltaic switch 215 and the photovoltaic output switch 372 to then be open and for all of the coupling switches, that is to say the first to third coupling switches 221 to 223 and also the first to third output coupling switches 361 to 263, to be closed, such that the wind power system 202 is able to use all of the inverters 231 to 234. Analogously, it also comes into consideration for the photovoltaic installation 204 to use all of the inverters 231 to 234 when there is very strong solar irradiation and no wind.

The output current switching device 360 thus creates a first and a second partial current output 381 and 382 in which a first partial output current I_{T1} and a second partial output current I_{T2} are output. These are fed to a first or second primary winding 383 or 384 of the transformer 316. They are then overlaid in the transformer 316 and output at the secondary winding 386 in the form of an overall output current I′_{G} with a stepped-up voltage. These two partial output currents I_{T1} and I_{T2} are thus able to be combined in spite of galvanic isolation. The wind power system 202 with the inverters assigned thereto, on the one hand, and the photovoltaic installation 204 with the inverters assigned thereto, on the other hand, are thus able to operate in a manner completely galvanically isolated from one another.

Both the intermediate circuit switching device 236 and the output current switching device 360 may each be referred to as or designed as a switching matrix. Such a switching matrix has a large number of individual switches, and corresponding current paths may be formed and desired elements may be electrically connected by correspondingly closing some switches and opening other switches.

The fundamental concept of one or more embodiments has been explained with reference to the figures, in particular with reference to FIGS. 2 and 3. In one or more embodiments, it is beneficial to design the intermediate circuit of a wind power installation to be divisible in the event of the additional connection of a photovoltaic installation. In this respect, all of the illustrated inverters 231 to 234 could be inverters of the wind power system 202, which are then also additionally used to invert power of the photovoltaic installation 204. This enhancement of the photovoltaic installation is achieved through the proposed circuitry, in particular through the intermediate circuit switching device 236.

The advantage of this is that the operating voltage of the corresponding DC voltage intermediate circuit, specifically in particular of the second partial intermediate circuit, is able to be adapted to the voltage of the photovoltaic installation that is required for the MPP method or occurs during the process. This voltage may also be referred to as MPP voltage. The intermediate circuit voltage of the wind power system, in particular of a corresponding wind power installation, is in this case not changed. The photovoltaic installation thereby does not require any additional galvanically isolated DC chopper, or galvanic isolation may be provided by the transformer. The proposed division is performed by a switching matrix that has been explained here in the form of an intermediate circuit switching device 236. As a result of this switching matrix, the inverters, in the practical implementation they are in particular corresponding control cabinets, may be distributed at least partly between the wind power system and the photovoltaic installation.

As a result of the anti-correlation between an infeed of wind energy, on the one hand, and photovoltaic energy, on the other hand, the inverters, which may also be referred to as converters, are thus assigned according to the infeed situation in different feeders, that is to say wind power system or photovoltaic installation, and optimum use is thereby essentially always made thereof.

Galvanic isolation may be implemented at the transformer, that is to say at the output side toward the transformer 316, by way of a second low-voltage winding that has been illustrated in the form of a second primary winding 384. The secondary winding, which may form a medium-voltage winding at the transformer 316, remains unchanged due to the overall power that remains essentially the same. In this case, a second switching matrix is provided at the transformer, specifically the output current switching device 360, that divides the inverters, that is to say in the practical implementation the power cabinets, over the two low-voltage windings, that is to say the first and second primary winding 383 and 384, for galvanic isolation purposes.

If, at a specific location, there are often times at which the overall power consisting of wind energy and solar energy exceeds the overall power of the wind power installation, the degree of integration may be brought to almost 100% through a slight overdimensioning, for example by in each case 10% at the transformer and in terms of the converter capacity. The photovoltaic installation 204 is thereby able to be integrated almost without losses into an existing wind power installation system, and may together form the renewable energy generation installation.

It has been recognized that when a photovoltaic installation, which may be abbreviated to PV installation, is intended to be connected to the DC voltage intermediate circuit of a wind power installation, the operating voltage of the PV installation needs to be adapted to the intermediate circuit voltage of the wind power installation, and the PV installation needs to be galvanically isolated from the wind power installation under certain circumstances. The solution illustrated here makes this possible by dividing the intermediate circuit of a wind power installation and assigning the inverters, which may also be referred to as converters, to one of the two intermediate circuits by way of a switching matrix.

It is thereby also possible to achieve joint use of hardware and infrastructure when connecting PV installations at a grid connection point of a wind power system.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An inverter arrangement, comprising:
a plurality of inverters, wherein each inverter of the plurality of inverters including a respective DC voltage intermediate circuit and a respective AC current output, wherein each inverter of the plurality of inverters is configured to generate an AC current from a DC voltage at the DC voltage intermediate circuit and output the AC current at the AC current output, and
an intermediate circuit switching device configured to electrically couple or to isolate the plurality of DC voltage intermediate circuits of the plurality of inverters to form at least one first partial intermediate circuit and at least one second partial intermediate circuit, the intermediate circuit switching device further configured to selectively galvanically couple each DC voltage intermediate circuit of the plurality of DC voltage intermediate circuits to the at least one first partial intermediate circuit or the at least one second partial intermediate circuit,
wherein the at least one first partial intermediate circuit and the at least one second partial intermediate circuit are galvanically isolated from each other.

2. The inverter arrangement according to claim 1, wherein each inverter of the plurality of inverters operates using a tolerance band method.

3. The inverter arrangement according to claim 1, comprising:
a first set of inverters having respective DC voltage intermediate circuits coupled to the first partial intermediate circuit are combined to form a first inverter sub-arrangement configured to generate a first partial AC current, and
a second set of inverters having respective DC voltage intermediate circuits coupled to the second partial intermediate circuit are combined to form a second inverter sub-arrangement configured to generate a second partial AC current,
wherein the first and second partial AC currents are combined to form an overall AC current to be fed into an electricity supply grid, and
wherein the intermediate circuit switching device is configured to selectively assign the first set of inverters to the first inverter sub-arrangement and the second set of inverters to the second inverter sub-arrangement.

4. The inverter arrangement according to claim 3, wherein AC current outputs of inverters of different inverter sub-arrangements are galvanically isolated from each other.

5. The inverter arrangement according to claim 3, wherein the inverters of the different inverter sub-arrangements are coupled to a transformer having at least two primary windings such that the first and second partial AC currents are overlaid in the transformer to form a joint AC current.

6. The inverter arrangement according claim 1, comprising:
an output current switching device configured to electrically couple or isolate AC current outputs of the plurality of inverters to form a first partial current output and a second partial current output, the output current switching device configured to galvanically couple each of the AC current outputs of the plurality of inverters to the first current output or second partial current output,
wherein the first and the second partial current outputs are galvanically isolated from one another by the output current switching device.

7. The inverter arrangement according claim 6, wherein the output current switching device is synchronized with the intermediate circuit switching device such that:
the first partial current output is assigned to the first inverter sub-arrangement, and
the second partial current output is assigned to the second inverter sub-arrangement.

8. The inverter arrangement according to claim 1, wherein:
the first partial intermediate circuit has a wind power terminal for coupling to a wind power system that has one or more wind power installations to thereby be configured to receive electric power generated by the wind power system,
the second partial intermediate circuit has a photovoltaic terminal for coupling to a photovoltaic installation to thereby be configured to receive electric power generated by the photovoltaic installation, and
the inverter arrangement is configured such that the intermediate circuit voltages differ between the first and second partial intermediate circuits.

9. The inverter arrangement according to claim 8, wherein an intermediate circuit voltage is set depending on an operating point of the photovoltaic installation at the second partial intermediate circuit.

10. The inverter arrangement according to claim 8, wherein:
the wind power system and the photovoltaic installation are each characterized by a nominal power, and
the inverter arrangement has a nominal power that corresponds to the nominal power of the wind power system plus a reserve power.

11. The inverter arrangement according to claim 10, wherein the reserve power corresponds to at most 20% of the nominal power of the wind power system.

12. The inverter arrangement according to claim 10, wherein the reserve power corresponds to a value that is less than 50% the nominal power of the photovoltaic installation.

13. A renewable energy generation installation for feeding electric power into an electricity supply grid, comprising:
at least one wind power system for generating electric power from wind;
at least one photovoltaic installation for generating electric power from solar radiation; and
an inverter arrangement according to claim 1.

14. The renewable energy generation installation according to claim 13, comprising:
a controller configured to control the inverter arrangement depending on power currently able to be generated from wind and power currently able to be generated from solar radiation,
wherein the at least one wind power system is coupled to the first partial intermediate circuit by a wind power terminal, and
wherein the at least one photovoltaic installation is coupled to the second partial intermediate circuit by a photovoltaic terminal.

15. The renewable energy generation installation according to claim 13, comprising:
an energy store configured to store or output electrical energy, and
an electrical consumer configured to consume electrical energy,
wherein the intermediate circuit switching device is configured to form a third partial intermediate circuit and a fourth partial intermediate circuit,
wherein the energy store is coupled to the third partial intermediate circuit, and
wherein the electrical consumer is coupled to the third or fourth partial intermediate circuit.

16. A method for controlling a renewable energy generation installation comprising:
using at least one wind power system, generating electric power from wind; and
using at least one photovoltaic installation, generating electric power from solar radiation;
wherein the renewable energy generation installation comprises an inverter arrangement having a plurality of inverters, wherein:
each inverter of the plurality of inverters has a respective DC voltage intermediate circuit and a respective AC current output, wherein the plurality of inverters generate an AC current from a DC voltage at the DC voltage intermediate circuit and outputs the AC current at the AC current output, and
the inverter arrangement has an intermediate circuit switching device that electrically couples or isolates the DC voltage intermediate circuits of the plurality of inverters and thereby forms at least one first partial intermediate circuit and one second partial intermediate circuit, and thereby galvanically couples the DC voltage intermediate circuits of each of the plurality inverters selectively to the first or second partial intermediate circuits,
the first and the second partial intermediate circuits are galvanically isolated from one another,
the wind power system is coupled to the first partial intermediate circuit by a wind power terminal and feeds the electric power generated from wind into the first partial intermediate circuit, and
the photovoltaic installation is coupled to the second partial intermediate circuit by a photovoltaic terminal and feeds the electric power generated from solar radiation into the second partial intermediate circuit.

17. The method according to claim 16, wherein each inverter operates using a tolerance band method.

18. The method according to claim 16, wherein:
a first set inverters having respective DC voltage intermediate circuit is coupled to the first partial intermediate circuit are combined to form a first inverter sub-arrangement to generate a first partial AC current, and
a second set inverters having respective DC voltage intermediate circuit is coupled to the second partial intermediate circuit are combined to form a second inverter sub-arrangement i to generate a second partial AC current, the method comprising:
combining the first and second partial AC currents to form an overall AC current to be fed into an electricity supply grid, and
wherein the plurality of inverters are assigned selectively to the first or second inverter sub-arrangement at least by way of the intermediate circuit switching device.

19. The method according to claim 18, wherein:
the inverter arrangement has an output current switching device that electrically couples or isolates the AC current outputs of a plurality of inverters and thereby forms a first partial current output and a second partial current output, and
each of the AC current outputs of the plurality inverters is galvanically selectively to the first or second partial current output, and
the output current switching device is synchronized with the intermediate circuit switching device such that the output current switching device and the intermediate circuit switching device are switched jointly,
the first partial current output is assigned to a first inverter sub-arrangement, and
the second partial current output is assigned to a second inverter sub-arrangement.

20. The method according to claim 16, wherein at least one of: the inverter arrangement, the intermediate circuit switching device, and the output current switching device is controlled depending on power currently able to be generated from wind and power currently able to be generated from solar radiation.
